(19) United States
(12) Patent Application Publication
(10) Pub. No.: US 2024/0414159 A1
(43) Pub. Date: Dec. 12, 2024

(54) SYSTEMS AND METHODS FOR MULTI-TENANT SEGMENTATION TO VIRTUALIZE ZTNA PROCESSING

(71) Applicant: Fortinet, Inc., Sunnyvale, CA (US)

(72) Inventor: Robert May, Burnaby (CA)

(73) Assignee: Fortinet, Inc., Sunnyvale, CA (US)

(21) Appl. No.: 18/208,371

(22) Filed: Jun. 12, 2023

(51) Int. Cl. H04L 9/40

(52) U.S. Cl. CPC H04L 63/10

(57) ABSTRACT

Systems, devices, and methods are discussed for providing virtualized ZTNA control across multiple networks.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2021, Fortinet, Inc.

### FIELD

Embodiments discussed generally relate to ZTNA, and more particularly to systems and methods for providing virtualized ZTNA control across multiple networks.

### BACKGROUND

Zero trust network access (ZTNA) is used to identify network elements and/or operations that are allowed within a given network environment, and to allow only those identified network elements and/or operations to operate in the network. Such an approach offers enhanced ability to secure a network environment from malicious attacks by disallowing any activity from a non-identified source. While such enhanced security is desirable, it does not work in a virtual environment as the ZTNA proxy is disposed near the resource to be accessed. This does not allow the possibility of distributing the resource to be accessed across multiple geographic regions.

Thus, there exists a need in the art for more advanced approaches, devices and systems for allowing ZTNA security without limiting the ability to distribute network resources across geographic regions.

### SUMMARY

Various embodiments provide systems and methods for providing virtualized ZTNA control across multiple networks.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1C illustrate a network architecture supporting multi-tenant ZTNA segmentation using ZTNA forward routing to privileged networks in accordance with some embodiments;

FIG. 2 is a flow diagram showing a method in accordance with various embodiments for performing zero trust network access for virtualized network access in accordance with various embodiments; and

FIG. 3 is a flow diagram showing a method in accordance with some embodiments for requesting ZTNA access to a desired resource using virtualized ZTNA access.

### DETAILED DESCRIPTION

Various embodiments provide systems and methods for providing virtualized ZTNA control across multiple networks.

As networks continue to grow it is desirable to services network access requests from a number of locations with each location offering substantially the same resources as the other locations. In this way, large numbers of accesses to the resources may be supported without overburdening one particular network server, and network access to the resources may be maintained when one or more of the locations become either inoperative or unreachable. Further, it is desirable to provide zero trust network access (“ZTNA”) in relation to network accesses to the resources in a way that does not require an end user accessing ZTNA protectable resources to maintain ZTNA access credentials specific to each of the locations.

In some embodiments, a ZTNA proxy server is used that performs both ZTNA processing and processes virtual access redirection. In such embodiments, a request would be sent to the requested resource via the ZTNA proxy server. The ZTNA proxy server performs regular ZTNA checks to identify the user, device, posture, and allow or deny access. The ZTNA proxy server further uses the information to determine the outgoing virtual routing and forwarding (VRF) instance for the session (this VRF connects the session to the right network). In some embodiments each of the aforementioned processes are transparent to the user/source, as it is a dynamic determination by the ZTNA Gateway based on various parameters of the source.

In some embodiments, a ZTNA proxy server is used that performs both ZTNA processing and processes virtual access redirection. In some cases, the ZTNA proxy server is implemented as part of a network appliance controlling access to a secure network. The ZTNA proxy server performs ZTNA processing as is known in the art that relies upon presentation of a local trust certificate generated by an access broker such as, for example, an element management system (“EMS”) as are known in the art. The local trust certificate identifies a resource that the user is permitted to access. The ZTNA proxy server performs ZTNA processing that grants or denies access to the local resource identified in the trust certificate. The ZTNA access message includes identification of the local resource and routing to access the local resource. Such an approach allows for limiting a requesting user's access on a granular basis with the granularity defined in the local trust certificate. However, unlike standard ZTNA where the access message is generated by the ZTNA server and provided in its entirety to the requesting user, in embodiments discussed herein this standard ZTNA message is not fully generated or provided to the requesting user.

In addition, once ZTNA access is authorized, the ZTNA proxy server identifies one of multiple virtual resources to handle an ongoing session with the requesting user. The ZTNA maintains virtual routing tables from which one of the multiple resources and routing from the user to the resource may be selected based upon one or more characteristics such as, for example, user location, resource availability, and/or route availability. In some embodiments, identifying the one of the multiple resources to handle the ongoing session may be done using virtual routing and forwarding (“VRF”) as is known in the art. The VRF may be either VRF lite or full VRF depending upon the demands of the particular implementation.

Once the ZTNA proxy server identifies one of the multiple virtual resources to service the request from the user, the ZTNA proxy server generates a ZTNA message that includes identification of the identified one of the multiple virtual resources and routing to access the identified resource. This ZTNA message is provided to the requesting user which in turn uses routing information included therein to open a session with the identified resource. The ZTNA proxy server further provides continuous checks on the user accessing the requested resource such that the user is constantly vetted to enhance network security. All of this is done as if the user were accessing the local resource indicated in the local trust certificate.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which example embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views or processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

Some embodiments provide methods for providing access to virtual resources in a network environment. Such methods include receiving, by a processing resource, a zero trust access request from a requester, where the zero trust access request identifies a resource to be accessed; determining, by the processing resource, that the requester is authorized to access the resource to be accessed; identifying, by the processing resource, a replica resource that replicates the resource to be accessed, where the replica resource is associated with a routing information; generating, by the processing resource, a response to the zero trust access request, where the response to the zero trust access request includes the routing information for the replica resource; and communicating, by the processing resource, the response to the zero trust access request to the requester.

In some such situations, the process includes a requester sending a request to access a resource where the request is sent to a zero trust network access gateway. The zero trust network access gateway performs standard zero trust network access checks to identify, for example, the user and device posture, and based thereon to allow or deny access. The zero trust network access gateway additionally identifies a replica resource that is a proxy or replica of the resource requested by the requester. A response is sent to the requester authorizing the requested access, but to the identified replica resource. The routing information for the replica resource included in the response sent to the requester and can be used by the requester to open a network session with the identified replica resource. In some cases, all of this processing is transparent to the requester, as it is a dynamic determination made by the zero trust network access gateway.

In some instances of the aforementioned embodiments, the resource to be requested is maintained in a secured network, the secured network is protected by a network security appliance, and the processing resource is incorporated in the network security appliance. In some such instances, the secured network is a first secured network, and the replica resource is maintained in a second secured network. In some cases where the network security appliance is a first network security appliance, access to the second secured network is controlled at least in part by a second network security appliance.

In various instances of the aforementioned embodiments, the routing information is a second routing information and the response to the zero trust access request is a second response to the zero trust access request. In such instances, determining that the requester is authorized to access the resource to be accessed includes generating a first response to the zero trust access request, and the first response to the zero trust access request includes a first routing information for the resource to be accessed. In some such instances, the methods further include: replacing, by the processing resource, the first routing information in the first response to the zero trust access request with the second routing information to yield the second response to the zero trust access request.

In some instances of the aforementioned embodiments, determining that the requester is authorized to access the resource to be accessed is done before identifying the replica resource. In other instances of the aforementioned embodiments, determining that the requester is authorized to access the resource to be accessed is done after identifying the replica resource. In various instances of the aforementioned embodiments, identifying the replica resource is based at least in part on one or both of a physical location of the requester, and/or a logical location of the requester.

Other embodiments provide systems for providing access to virtual resources in a network environment. The systems include a processing resource and a non-transitory computer-readable medium coupled to the processing resource. The non-transitory computer readable medium has stored therein instructions that when executed by the processing resource cause the processing resource to: receive a zero trust access request from a requester, wherein the zero trust access request identifies a resource to be accessed; determine that the requester is authorized to access the resource to be accessed; identify a replica resource that replicates the resource to be accessed, wherein the replica resource is associated with a routing information; generate a response to the zero trust access request, wherein the response to the zero trust access request includes the routing information for the replica resource; and communicate the response to the zero trust access request to the requester.

Yet other embodiments provide non-transitory computer-readable storage media each embodying a set of instructions, which when executed by a processing resource, causes the processing resource to: receive a zero trust access request from a requester, wherein the zero trust access request identifies a resource to be accessed; determine that the requester is authorized to access the resource to be accessed; identify a replica resource that replicates the resource to be accessed, wherein the replica resource is associated with a routing information; generate a response to the zero trust access request, wherein the response to the zero trust access request includes the routing information for the replica resource; and communicate the response to the zero trust access request to the requester.

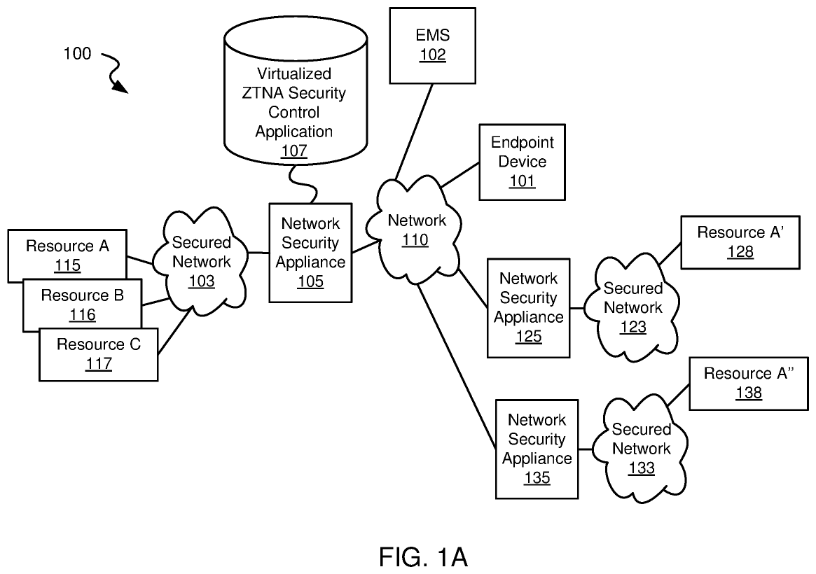

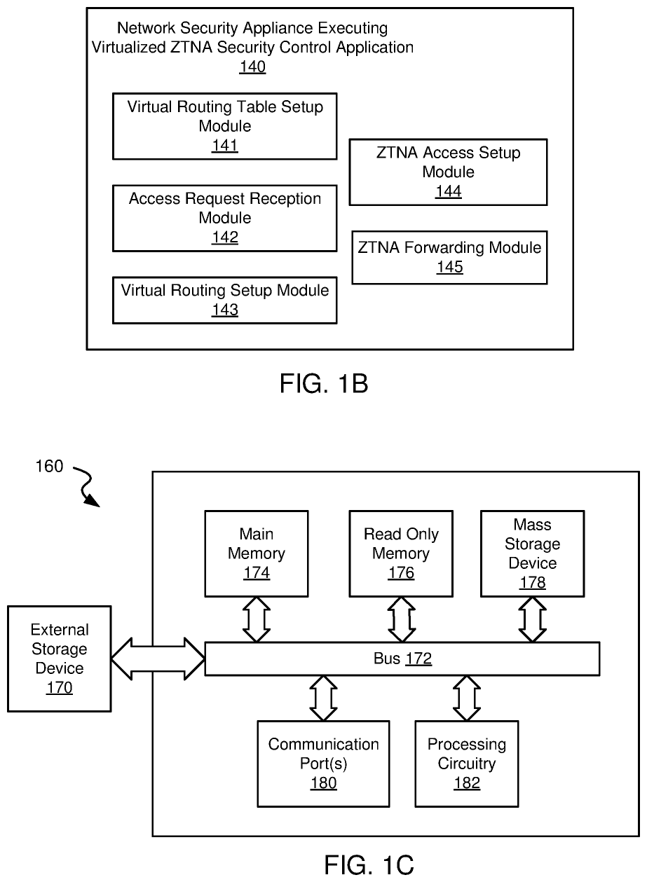

Turning to FIG. 1A, a network architecture 100 supporting multi-tenant ZTNA segmentation using ZTNA forward routing to privileged networks in accordance with some embodiments. As shown, network architecture 100 includes a first secured network 103 providing access to an endpoint device 113, a resource A 115, a resource B 116, and a resource C 117. The aforementioned resources may be any resource accessible via a communication network and thus include, but are not limited to, a database, an application, and/or a server. Based upon the disclosure provided herein one of ordinary skill in the art will recognize a variety of resource types that can be supported in accordance with different embodiments.

Access to first secured network 103 is governed by a network security appliance 105. Network security appliance executes a virtualized ZTNA security control application maintained on a computer readable medium 107. Execution of the virtualized ZTNA security control application implements a ZTNA proxy capable of virtualized resource access in accordance with some embodiments. Secured network 103 may be any communication systems or collection of communication systems that provide for network communications between respective networks. Those skilled in the art will appreciate that, secured network 103 can be a wireless network, a wired network or a combination thereof that can be implemented as one of the various types of networks, such as the Internet, an Intranet, a Local Area Network (LAN), a Wide Area Network (WAN), and the like.

One or more of the resources accessed via secured network 103 may be replicated and accessible via other secured networks. For example, a resource A′ 128 may be accessed via a secured network 123 that is controlled by a network security appliance 125; and a resource A″ 138 may be accessed via a secured network 133 that is controlled by a network security appliance 135. Each of resource A′ 128 and resource A″ 138 is a replica of resource A 115. Each of secured network 123 and secured network 133 may be any communication systems or collection of communication systems that provide for network communications between respective networks. Those skilled in the art will appreciate that, either or both of secured network 123 and/or secured network 133 can be a wireless network, a wired network or a combination thereof that can be implemented as one of the various types of networks, such as the Internet, an Intranet, a Local Area Network (LAN), a Wide Area Network (WAN), and the like.

An EMS 102 operates to grant local trust certificates in a ZTNA implementation. Any EMS known in the art may be used in relation to different embodiments. An endpoint device 101 may used by a user to access EMS 102 or any of secured networks 103, 123, 133 via a communication network 110. Communication network 110 may be any communication systems or collection of communication systems that provide for network communications between respective networks. Those skilled in the art will appreciate that, secured network 110 can be a wireless network, a wired network or a combination thereof that can be implemented as one of the various types of networks, such as the Internet, an Intranet, a Local Area Network (LAN), a Wide Area Network (WAN), and the like.

Turning to FIG. 1B, an implementation of a network security appliance executing a virtualized ZTNA Security Control Application 140 is shown in accordance with some embodiments. In this embodiment, network security appliance executing a virtualized ZTNA Security Control Application 140 includes a virtual routing table setup module 141, an access request reception module 142, a virtual routing setup module 143, a ZTNA access setup module 144, and a ZTNA forwarding module 145.

Virtual routing table setup module 141 is configured to aid an administrator in setting up a number of resources and identifying replica resources along with location and routing information for the replica resources. The result is virtual routing tables that can be used to redirect a ZTNA access from a resource for which a local trust certificate is held to another replica resource.

Access request reception module 142 is configured to receive a request to access one or more resources included in a secured network. The request to access includes a local trust certificate designated to allow access to a requested resource maintained on the secured network.

Virtual routing setup module 143 is configured to access one or more virtual routing tables to identify one or more replica resources that may be used in place of the requested resource. The replica resources may exist at other physical locations than the requested resource and/or included as part of secured networks apart from the secured network where the requested resource exists. Virtual routing setup module 143 additionally selects one of the identified replica sources. The virtual routing process performed by virtual routing setup module 143 yields routing and endpoint information for the selected replica resource that may be provided to a requester such that the requester can access the replica resource directly. The virtual routing may be done using any virtual routing approach known in the art. For example, in some embodiments either full VRF or VRF lite may be used to perform the virtual routing. Further, in some embodiments, the virtual routing is done based at least in part on the physical location of the endpoint device from which the request was received. In another embodiment, the virtual routing is done based at least in part on the logical location of the endpoint device from which the request was received. Based upon the disclosure provided herein, one of ordinary skill in the art will recognize a variety of approaches for performing virtual routing and/or basis for the virtual routing that may be used in relation to different embodiments to select which of a number of replica resources to assign to fulfill a request.

ZTNA access setup module 144 is configured to determine whether a ZTNA request is allowable based in part upon a local trust certificate received as part of a request. Where the requested ZTNA access is allowed, ZTNA access setup module 144 prepare a ZTNA message for the requester. The ZTNA message includes an indication of the requested resource and routing information to the requested resource.

ZTNA forwarding module 145 is configured to modify the ZTNA message from ZTNA access setup module 144 to include the replica resource and corresponding routing information generated by virtual routing setup module 143, and to forward the modified ZTNA message to the requester. As such, the requester is provided ZTNA access to a replica resource when it had asked for access to a given resource that is replicated by the replica resource.

Turning to FIG. 1C, an example computer system 160 is shown in which or with which embodiments of the present disclosure may be utilized. As shown in FIG. 1C, computer system 160 includes an external storage device 170, a bus 172, a main memory 174, a read-only memory 176, a mass storage device 178, one or more communication ports 1010, and one or more processing resources (e.g., processing circuitry 182). In one embodiment, computer system 160 may represent some portion of security orchestration system 120, network security appliance 115, one or more computers on which applications A 110, application B 111, and/or application C 112 are executing, and/or one or more network servers governing database A 106, database B 107, and/or database C 108.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g. start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing resources to software system.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc-Read Only Memory (CD-ROM), Compact Disc—Rewritable (CD-RW), Digital Video Disk-Read Only Memory (DVD-ROM). Components described above are meant only to show various possibilities. In no way should the aforementioned example computer system limit the scope of the present disclosure.

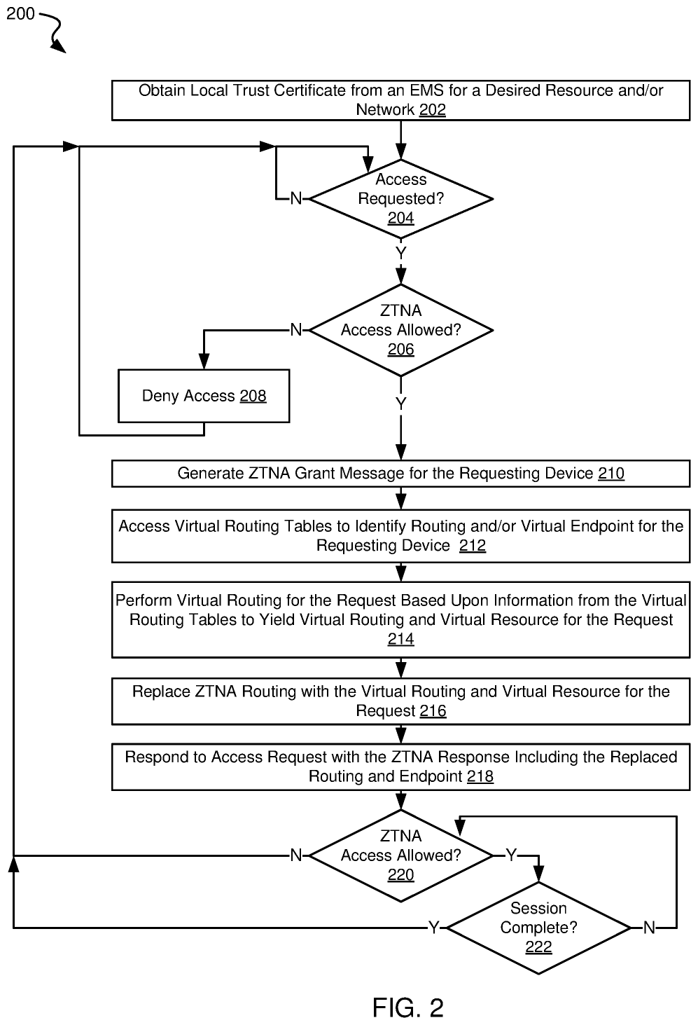

Turning to FIG. 2, a flow diagram 200 shows a method in accordance with various embodiments for performing zero trust network access for virtualized network access. Following flow diagram 200, a local trust certificate is obtained from an EMS for a desired resource and/or network (block 202). Such local trust certificates are available to a user based upon network protocols. The local trust certificate may be highly granular and only allows the user a particular type of access to a particular resource. In other cases, the local trust certificate may be broader allowing a user full access to a secured network. Based upon the disclosure provided herein, one of ordinary skill in the art will recognize a variety of access breadths that may be granted to a particular user in a particular embodiment. Obtaining the local trust certificate includes providing a request to the EMS that identifies the user making the request and the resource and/or network access being requested. In turn, the EMS checks appropriate network protocols to assure the request is acceptable, and where acceptable issues the local trust certificate to the requester. As part of registering the requester and granting the local trust certificate, the EMS continues to monitor the security posture of the requester to assure that nothing changes that would warrant revoking the local trust certificate as is known in the art. Any approach known in the art for generating a local trust certificate may be used in relation to different embodiments. As just an example, the request for the local trust certificate may be made by endpoint device 101 to EMS 102 via communication network 110, and request access to resource 115.

It is determined whether a request has been made for access to a resource within a secured network using a local trust certificate (block 204). Thus, for example, network security appliance 105 may determine that endpoint device 101 is requesting access to resource A 115 using a local trust certificate.

Where it is determined that an access has been requested (block 204), the recipient of the access request performs standard ZTNA access granting procedures using the local trust certificate to determine whether the requested ZTNA access is allowed (block 206). Using the example above, it is network security appliance 105 that makes the determination as to whether the requested ZTNA access is allowed. Where ZTNA access is not allowed because, for example, the local trust certificate is not correct or has been revoked (block 206), the access is denied (block 208) and the process returns to block 204.

Where, on the other hand, ZTNA access is allowed (block 206), ZTNA message is generated for the requesting device (block 210). The ZTNA message includes routing information and identification of the resource to which access has been granted. This information, if provided to the requester, could be used by the requester to access the requested resource directly. Using the example from above where the requester requested access to resource A 115, the ZTNA message would include identification of resource A 115 and routing information to access resource A 115.

Virtual routing tables are accessed to determine which virtual resource is to be used by the requesting user (block 212). The virtual routing tables include a listing of resources and replicas of the resources that are available at different physical locations and/or within different secured networks. Thus, where resource A 115 is requested, the virtual resource tables will list each of resource A′ 128 and resource A′ 138 which are replicas of the requested resource A 115.

Virtual routing is performed to identify which of either the requested resource or one of a number of replica resources will be assigned to complete the request (block 214). The virtual routing process yields routing and endpoint information for the selected replica resource that may be provided to a requester such that the requester can access the replica resource directly. The virtual routing may be done using any virtual routing approach known in the art. For example, in some embodiments either full VRF or VRF lite may be used to perform the virtual routing. Further, in some embodiments, the virtual routing is done based at least in part on the physical location of the endpoint device from which the request was received. In another embodiment, the virtual routing is done based at least in part on the logical location of the endpoint device from which the request was received. Based upon the disclosure provided herein, one of ordinary skill in the art will recognize a variety of approaches for performing virtual routing and/or basis for the virtual routing that may be used in relation to different embodiments to select which of a number of replica resources to assign to fulfill a request.

The identified resource and routing information in the ZTNA message generated as part of block 210 is replaced with the virtual endpoint and virtual routing generated as part of the virtual routing process of block 214 (block 216). Thus, the ZTNA message which was originally designed to grant access to the requested resource, is modified to direct access to a replica of the requested resource. Thus, where the original ZTNA message identified resource A 115 and corresponding routing, the ZTNA message may be modified to identify, for example, resource A′ 128 and corresponding routing. A response is then provided to the requester that includes the modified ZTNA message (block 218).

Similar to prior art ZTNA accesses, the security posture of the requesting device is continuously monitored to determine whether ZTNA access continues to be authorized (block 220). At anytime where ZTNA access becomes unauthorized (block 220), the session is terminated and processing returns to block 204. Alternatively, where the session completes (block 222), processing is returned to block 204.

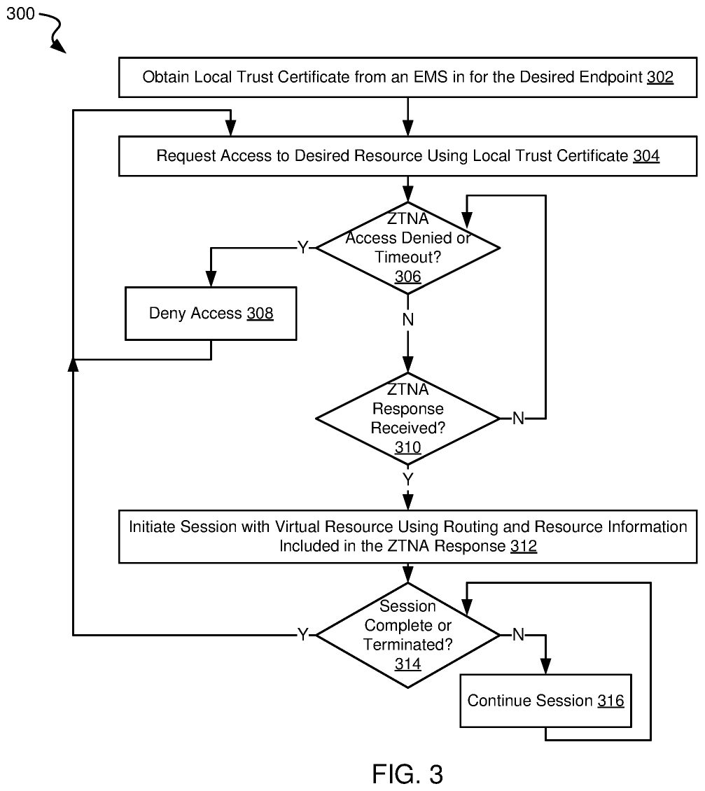

Turning to FIG. 3, a flow diagram 300 shows a method in accordance with some embodiments for requesting ZTNA access to a desired resource using virtualized ZTNA access. Following flow diagram 300, a local trust certificate is obtained from an EMS for a desired resource and/or network (block 302). Such local trust certificates are available to a user based upon network protocols. The local trust certificate may be highly granular and only allows the user a particular type of access to a particular resource. In other cases, the local trust certificate may be broader allowing a user full access to a secured network. Based upon the disclosure provided herein, one of ordinary skill in the art will recognize a variety of access breadths that may be granted to a particular user in a particular embodiment. Obtaining the local trust certificate includes providing a request to the EMS that identifies the user making the request and the resource and/or network access being requested. In turn, the EMS checks appropriate network protocols to assure the request is acceptable, and where acceptable issues the local trust certificate to the requester. As part of registering the requester and granting the local trust certificate, the EMS continues to monitor the security posture of the requester to assure that nothing changes that would warrant revoking the local trust certificate as is known in the art. Any approach known in the art for generating a local trust certificate may be used in relation to different embodiments. As just an example, the request for the local trust certificate may be made by endpoint device 101 to EMS 102 via communication network 110, and request access to resource 115.

A request to access a desired resource is sent to a secured network including the resource (block 304). This request includes the local trust certificate received from the EMS. Thus, for example, where access to resource A 115 is being requested, endpoint device 101 provides the local trust certificate to network security appliance 105 via communication network 110.

It is determined whether the requested ZTNA access has been denied or timed out (block 306). Where the request has either been denied or has timed out (block 306), a denial of access is indicated (block 308) and the processing returns to block 304. Otherwise, it is determined whether a response to the ZTNA request has been received (block 310). Where a ZTNA response has been received (block 310), a communication session is initiated with the virtual resource indicated in the received ZTNA message using the included replica resource and routing information (block 312). This session continues (block 316) until it is either completed or terminated (block 314).

In conclusion, the present disclosure provides for novel systems, devices, and methods. While detailed descriptions of one or more embodiments have been given above, various alternatives, modifications, and equivalents will be apparent to those skilled in the art. Therefore, the above description should not be taken as limiting the scope of the invention, which is defined by the appended claims.

What is claimed is:

1. A method for providing access to virtual resources in a network environment, the method comprising:
receiving, by a processing resource, a zero trust access request from a requester, wherein the zero trust access request identifies a resource to be accessed;
determining, by the processing resource, that the requester is authorized to access the resource to be accessed;
identifying, by the processing resource, a replica resource that replicates the resource to be accessed, wherein the replica resource is associated with a routing information;
generating, by the processing resource, a response to the zero trust access request, wherein the response to the zero trust access request includes the routing information for the replica resource; and
communicating, by the processing resource, the response to the zero trust access request to the requester.

2. The method of claim 1, wherein the resource to be requested is maintained in a secured network, and wherein the secured network is protected by a network security appliance, and wherein the processing resource is incorporated in the network security appliance.

3. The method of claim 2, wherein the secured network is a first secured network, and wherein the replica resource is maintained in a second secured network.

4. The method of claim 3, wherein the network security appliance is a first network security appliance, and wherein access to the second secured network is controlled at least in part by a second network security appliance.

5. The method of claim 1, wherein the routing information is a second routing information, wherein the response to the zero trust access request is a second response to the zero trust access request, wherein determining that the requester is authorized to access the resource to be accessed includes generating a first response to the zero trust access request, and wherein the first response to the zero trust access request includes a first routing information for the resource to be accessed.

6. The method of claim 5, the method further comprising:
replacing, by the processing resource, the first routing information in the first response to the zero trust access request with the second routing information to yield the second response to the zero trust access request.

7. The method of claim 1, wherein determining that the requester is authorized to access the resource to be accessed is done before identifying the replica resource.

8. The method of claim 1, wherein determining that the requester is authorized to access the resource to be accessed is done after identifying the replica resource.

9. The method of claim 1, wherein identifying the replica resource is based at least in part on a requester characteristic selected from a group consisting of: a physical location of the requester, and a logical location of the requester.

10. A system for providing access to virtual resources in a network environment, the system comprising:
a processing resource;
a non-transitory computer-readable medium, coupled to the processing resource, having stored therein instructions that when executed by the processing resource cause the processing resource to:
receive a zero trust access request from a requester, wherein the zero trust access request identifies a resource to be accessed;
determine that the requester is authorized to access the resource to be accessed;
identify a replica resource that replicates the resource to be accessed, wherein the replica resource is associated with a routing information;
generate a response to the zero trust access request, wherein the response to the zero trust access request includes the routing information for the replica resource; and
communicate the response to the zero trust access request to the requester.

11. The system of claim 10, wherein the resource to be requested is maintained in a secured network, and wherein the secured network is protected by a network security appliance, and wherein the processing resource is incorporated in the network security appliance.

12. The system of claim 11, wherein the secured network is a first secured network, and wherein the replica resource is maintained in a second secured network.

13. The system of claim 12, wherein the network security appliance is a first network security appliance, and wherein access to the second secured network is controlled at least in part by a second network security appliance.

14. The system of claim 11, wherein the routing information is a second routing information, wherein the response to the zero trust access request is a second response to the zero trust access request, wherein determining that the requester is authorized to access the resource to be accessed includes generating a first response to the zero trust access request, and wherein the first response to the zero trust access request includes a first routing information for the resource to be accessed.

15. The system of claim 14, wherein the a non-transitory computer-readable medium further has stored therein instructions that when executed by the processing resource cause the processing resource to: replace the first routing information in the first response to the zero trust access request with the second routing information to yield the second response to the zero trust access request.

16. The system of claim 15, wherein determining that the requester is authorized to access the resource to be accessed is done before identifying the replica resource.

17. The system of claim 10, wherein determining that the requester is authorized to access the resource to be accessed is done after identifying the replica resource.

18. The system of claim 10, wherein identifying the replica resource is based at least in part on a requester characteristic selected from a group consisting of: a physical location of the requester, and a logical location of the requester.

19. A non-transitory computer-readable storage medium embodying a set of instructions, which when executed by a processing resource, causes the processing resource to:
receive a zero trust access request from a requester, wherein the zero trust access request identifies a resource to be accessed;
determine that the requester is authorized to access the resource to be accessed;
identify a replica resource that replicates the resource to be accessed, wherein the replica resource is associated with a routing information;
generate a response to the zero trust access request, wherein the response to the zero trust access request includes the routing information for the replica resource; and
communicate the response to the zero trust access request to the requester.

20. The non-transitory computer-readable storage medium of claim 19, wherein the resource to be requested is maintained in a secured network, and wherein the secured network is protected by a network security appliance, and wherein the processing resource is incorporated in the network security appliance.
